(19) United States
(12) Patent Application Publication
(10) Pub. No.: US 2017/0311179 A1
(43) Pub. Date: Oct. 26, 2017

(54) WIRELESS COMMUNICATION APPARATUS, BEAM SEARCH METHOD, AND NON-TRANSITORY COMPUTER-READABLE STORAGE MEDIUM

(71) Applicant: FUJITSU LIMITED, Kawasaki-shi (JP)

(72) Inventor: Shunsuke FUJIO, Kawasaki (JP)

(73) Assignee: FUJITSU LIMITED, Kawasaki-shi (JP)

(21) Appl. No.: 15/491,262

(22) Filed: Apr. 19, 2017

(30) Foreign Application Priority Data
Apr. 26, 2016 (JP) 2016-088043

(51) Int. Cl. H04W 16/28; H04W 24/08; H04W 64/00; H04W 72/04

(52) U.S. Cl. CPC H04W 16/28; H04W 72/046; H04W 24/08; H04W 64/006

(57) ABSTRACT

A wireless communication apparatus including a memory and a processor coupled to the memory and the processor configured to transmit a plurality of radio signals for a plurality of directions by forming a plurality of first beams, each of plurality of first beams having a directivity in at least two directions, estimate a direction in which a reception apparatus is located based on first reception quality information indicating a reception quality when the reception apparatus receives at least one radio signal included in the plurality of radio signals, and perform a radio communication with the reception apparatus by forming a beam corresponding to the estimated direction.

### CROSS-REFERENCE TO RELATED APPLICATION

This application is based upon and claims the benefit of priority of the prior Japanese Patent Application No. 2016-088043, filed on Apr. 26, 2016, the entire contents of which are incorporated herein by reference.

### FIELD

The embodiments discussed herein are related to a wireless communication apparatus, a beam search method, and a non-transitory computer-readable storage medium.

### BACKGROUND

In wireless communication using a high frequency band, such as millimeter wave communication, or the like, the transmission loss is large, and thus beamforming by a multi-element antenna is sometimes used. When beamforming is performed, a high reception power is obtained by turning beams toward a suitable direction. However, if the beam direction is not suitable, it might be difficult to obtain reception power requested for the communication.

Thus, as a method of estimating a suitable direction, a method which is referred to as a beam search and in which a base station spatially scans beams is known. In a beam search, a base station transmits beams having directivities in respective different directions in sequence and estimates the direction of a terminal based on the reception quality information of each beam notified from each terminal.

A beam search is sometimes performed in two stages. For example, there is a technique that is performed in two stages as follows. In the first stage, a rough estimation is made of the range in which a terminal is located using thick beams (in other words, “beams having a wide transmission angle”). In the second stage, a detailed search is made particularly for the direction of the terminal in the estimated range (refer to International Publication Pamphlet No. WO 2014/054908).

Also, a beam search is sometimes used in combination with beam tracking. Beam tracking is a technique for causing a beam to track the movement of a terminal whose direction was estimated in the past. For example, a technique is known in which a base station transmits beams in one direction at a time in sequence for a plurality of directions in the vicinity of the terminal direction that was estimated at the previous time, and information indicating a beam having a high reception power is notified from the terminal so that beam tracking is performed (refer to Yuki Inoue, et al., “Experimental Evaluation of Downlink Transmission and beam tracking Performance for 5G mmW Radio Access in Indoor Shielded Environment,” IEEE PIMRC, September 2015).

As patent literature, related-art techniques are disclosed in Japanese Laid-open Patent Publication Nos. 9-162799, 2014-036325, and 2015-164281, and Japanese National Publication of International Patent Application No. 2004-507151.

### SUMMARY

According to an aspect of the invention, a wireless communication apparatus including a memory and a processor coupled to the memory and the processor configured to transmit a plurality of radio signals for a plurality of directions by forming a plurality of first beams, each of plurality of first beams having a directivity in at least two directions, estimate a direction in which a reception apparatus is located based on first reception quality information indicating a reception quality when the reception apparatus receives at least one radio signal included in the plurality of radio signals, and perform a radio communication with the reception apparatus by forming a beam corresponding to the estimated direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of an example of the related art two-stage beam search method;

FIG. 2 is an explanatory diagram of an example of the related art beam tracking;

FIG. 3 is an explanatory diagram of the case where the two-stage beam search illustrated in FIG. 1 is applied to a plurality of terminals;

FIG. 4 is an explanatory diagram of the case where the beam tracking illustrated in FIG. 2 is applied to a plurality of terminals;

FIG. 5 is a block diagram illustrating an example of a configuration of a wireless communication system according to an embodiment;

FIG. 6 is a block diagram schematically illustrating the functions of a memory in the base station illustrated in FIG. 5;

FIG. 7 is a block diagram schematically illustrating the functions of a processor in the base station illustrated in FIG. 5;

FIG. 8 is a diagram schematically illustrating an example of a beam set that is transmitted by the base station according to the embodiment;

FIG. 9 is a flowchart illustrating estimation operation of a terminal direction in the base station according to the embodiment:

FIG. 10 is a flowchart illustrating the detailed processing of step S4 in FIG. 9 when the past estimation result of the terminal direction is not held;

FIG. 11 is a flowchart illustrating the detailed processing of step S4 in FIG. 9 when the past estimation result of the terminal direction is held;

FIG. 12 is a block diagram schematically illustrating the functions of a processor in the base station in a first variation;

FIG. 13 is a block diagram schematically illustrating a relationship between the reception quality of a terminal according to the first variation and an upper limit value of the number of tracking candidates;

FIG. 14 is a diagram schematically illustrating an example of a beam set transmitted by the base station according to the first variation;

FIG. 15 is a flowchart illustrating determination operation of a beam set in the base station according to the first variation;

FIG. 16 is a flowchart illustrating change operation of the beam set determination methods in the base station according to the first variation;

FIG. 17 is a block diagram schematically illustrating the functions of a processor in a base station according to a second variation; and

FIG. 18 is a flowchart illustrating estimation operation of a terminal direction in the base station according to the second variation.

### DESCRIPTION OF EMBODIMENTS

However, with the above-described beam search and beam tracking, when a large number of terminals are distributed in a wide range in a wireless communication area, a base station transmits multiple beams to the terminals. Accordingly, a large amount of radio resources might be consumed in order to estimate the terminal directions.

According to an aspect of the technique described in this specification, it is desirable to reduce radio resources consumed for estimation of a terminal direction.

In the following, a description will be given of embodiments with reference to the drawings. However, the embodiments described below are only examples, and there are no intentions to exclude various variations and application of techniques that are not clearly specified in the embodiments. For example, it is possible to make various variations of the present embodiments and to carry out implementation without departing from the spirit and scope thereof.

Also, it is not intended that each figure includes only the components illustrated in the figure, and thus it is possible to include the other components. In the following, a part given the same symbol in the figures indicates the same or the similar part unless otherwise specified in particular.

### 1. Related Art Techniques

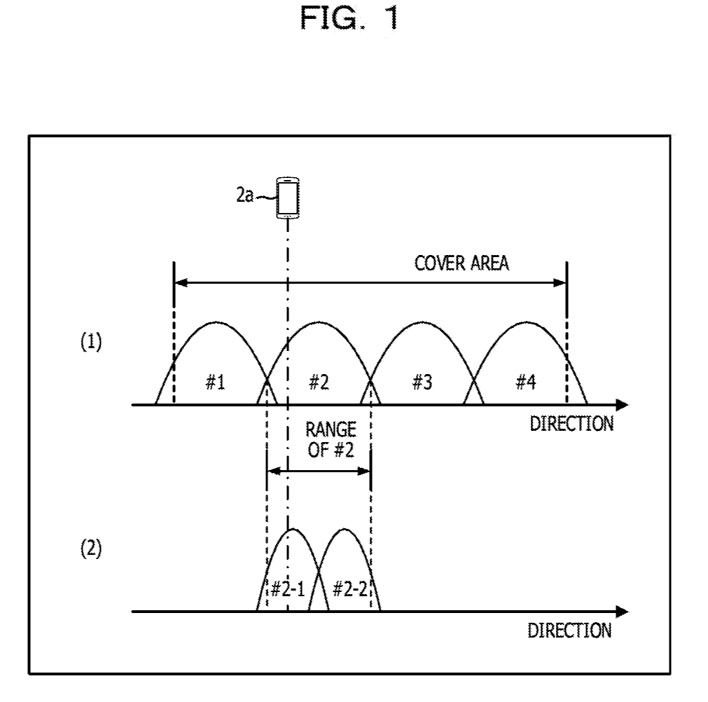

FIG. 1 is an explanatory diagram of an example of the related art two-stage beam search method.

As illustrated in FIG. 1(1), a range in which a terminal 2a is located is roughly estimated using thick beams (in other words, “beams having a wide transmission angle”) in the first stage. A base station (not illustrated in FIG. 1) transmits a plurality of (four in the example illustrated in FIG. 1) beams #1 to #4 to the entire cover area of the base station.

As illustrated in FIG. 1(2), a detailed search is made only in the estimated area in the second stage. If the reception power of the beam #2 at a terminal 2a is higher than the reception power of the other beams #1, #3, and #4, the base station estimates that the terminal 2a is located in the cover area of the beam #2. The base station then transmits a plurality of (two in the example illustrated in FIG. 1) thinner beams (in other words, “beams having a narrower transmission angle”) #2-1 and #2-2 than the beams #1 to #4 to the cover area of the estimated beam #2.

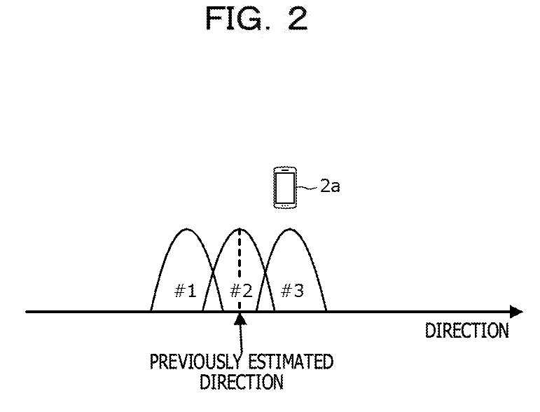

FIG. 2 is an explanatory diagram of an example of the related art beam tracking.

As illustrated in FIG. 2, the base station (not illustrated in FIG. 2) transmits a plurality of (three in the example illustrated in FIG. 2) beams #1 to #3 in the vicinity of the terminal direction that was estimated at the previous time in one direction at a time in sequence. If the terminal 2a receives the beam #3 having a higher reception power than the beams #1 and #2, the base station estimates that the terminal 2a is located in the cover area of the beam #3.

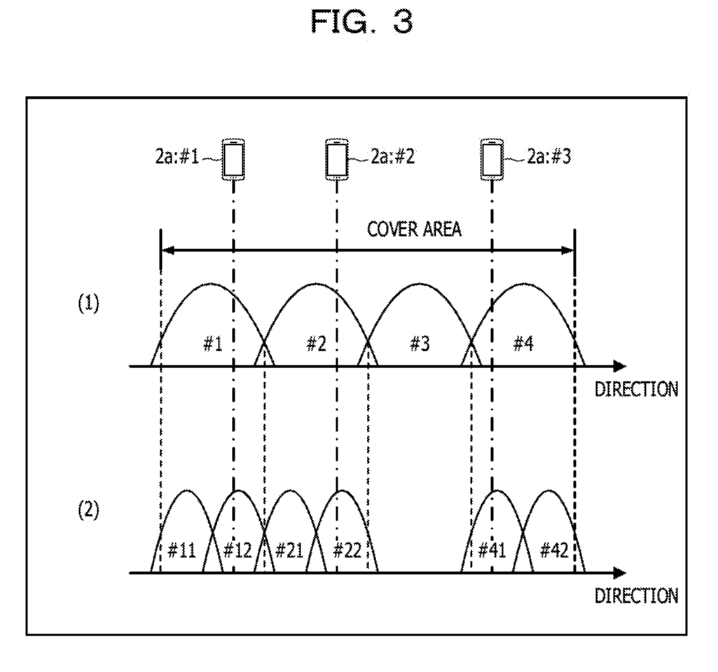

FIG. 3 is an explanatory diagram of the case where the two-stage beam search illustrated in FIG. 1 is applied to a plurality of terminals 2a.

In the example illustrated in FIG. 3, three terminals 2a (may be referred to as “terminals #1 to #3”) are located in the cover area of a base station (not illustrated in FIG. 3).

As illustrated in FIG. 3(1), the base station transmits four thick beams #1 to #4 to the entire cover area.

When the terminals #1 to #3 receive the beams #1, #2, and #4 having a higher reception power than the reception power of the beam #3, the base station estimates that the three terminals 2a are located in the respective cover areas of the beams #1, #2, and #4.

As illustrated in FIG. 3(2), the base station transmits a plurality of (two in the example illustrated in FIG. 3) thinner beams (in other words, “beam having a narrow transmission angle”) than the beams #1, #2, and #4 to the cover areas of the estimated beams #1, #2, and #4. The thinner beams that are transmitted in the cover area of the beam #1 may be referred to as beams #11 and #12. The thinner beams that are transmitted in the cover area of the beam #2 may be referred to as beams #21 and #22. The thinner beams that are transmitted in the cover area of the beam #4 may be referred to as beams #41 and #42.

In this manner, if the terminals 2a are found in the respective cover areas of a plurality of beams by the beam search in the first stage, beams have to be transmitted to a wide area in the second stage.

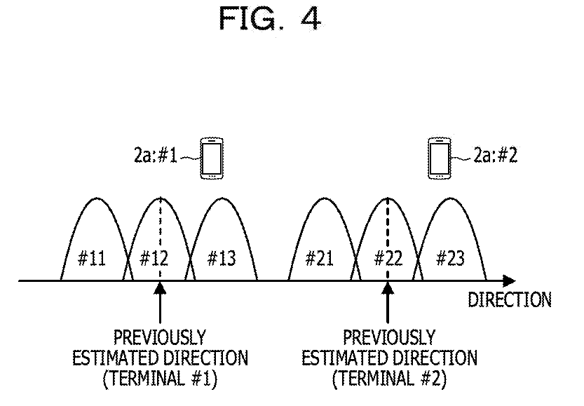

FIG. 4 is an explanatory diagram of the case where the beam tracking illustrated in FIG. 2 is applied to a plurality of terminals 2a.

In the example illustrated in FIG. 4, two terminals 2a (may be referred to as “terminals #1 and #2”) are located in the cover area of a base station (not illustrated in FIG. 4).

As illustrated in FIG. 4, the base station transmits a plurality of (three in the example in FIG. 4) beams in one direction at a time in sequence respectively in the vicinity of the terminal directions that were estimated at the previous time. That is to say, the base station transmits three beams #11, #12, and #13 in one direction at a time in sequence in the vicinity of the previously estimated direction of the terminal #1. Also, the base station transmits three beams #21, #22, and #23 in one direction at a time in sequence in the vicinity of the previously estimated direction of the terminal #2.

If the terminal #1 receives the beam #13 having a higher reception power than the reception powers of the beams #11 and #12, the base station estimates that the terminal #1 is located in the cover area of the beam #13. Also, if the terminal #2 receives the beam #23 having a higher reception power than the reception powers of the beams #21 and #22, the base station estimates that the terminal #2 is located in the cover area of the beam #23.

In this manner, if terminals 2a are distributed in a wide range, the total number of transmission beams to be used for tracking all the terminals 2a increases. Also, if the beams used for beam search and beam tracking are different, the beam search and the beam tracking are separately performed, and thus the total number of transmission beams increases.

### 2. Embodiment

2.1 Example of System Configuration

A base station 1 according to an embodiment has, for example, a system configuration described below in order to estimate a terminal direction with a smaller number of beams even if many terminals 2 are distributed in a wide range.

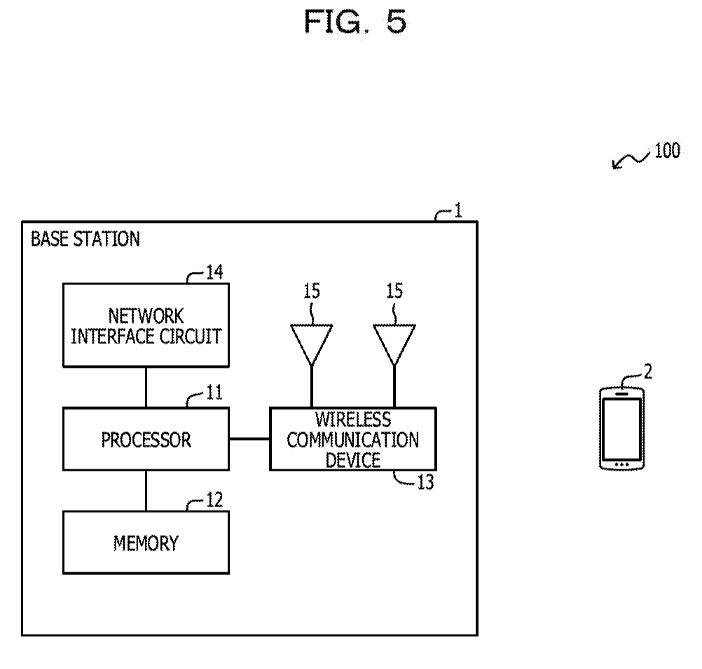

FIG. 5 is a block diagram illustrating an example of a configuration of a wireless communication system 100 according to the embodiment.

As illustrated in FIG. 5, the wireless communication system 100 includes the base station 1 and a wireless communication terminal (may be simply referred to as a “terminal”) 2.

The terminal 2 is an example of a reception apparatus that transmits and receives a radio signal with the base station 1. The terminal 2 is portable by a user, and may be referred to as a mobile station.

The base station 1 is an example of a wireless communication apparatus that transmits and receives a radio signal with the terminal 2. The base station 1 includes a processor 11, a memory 12, a wireless communication device 13, a network interface circuit 14, and a plurality of (two in the example illustrated in FIG. 5) antennas 15.

The antennas 15 transmit and receive radio signals with the terminal 2, and may be referred to as elements. The element spacing of the individual antennas 15 may be d [m], and a plurality of antennas 15 may form a uniform linear array antenna.

The wireless communication device 13 is coupled to a plurality of antennas 15, and is provided with an analog circuit used for transmitting and receiving radio signals from the antennas 15. For example, the wireless communication device 13 is provided with an analog circuit (TX) of a transmission system and an analog circuit (RX) of a reception system for each of the antennas 15.

The network interface circuit 14 is an interface circuit that performs communication control with the other apparatuses. For example, the network interface circuit 14 is coupled to a wired network of a backbone included in a mobile communication network, and is capable of transmitting and receiving various kinds of information with the other base stations (not illustrated in FIG. 5).

The memory 12 is a storage device that illustratively includes a read only memory (ROM) and a random access memory (RAM). Programs, such as a basic input/output system (BIOS), and the like may be written in the ROM of the memory 12. A software program in the memory 12 may be suitably read and executed by the processor 11. Also, the RAM of the memory 12 may be used as a primary recording memory or a working memory.

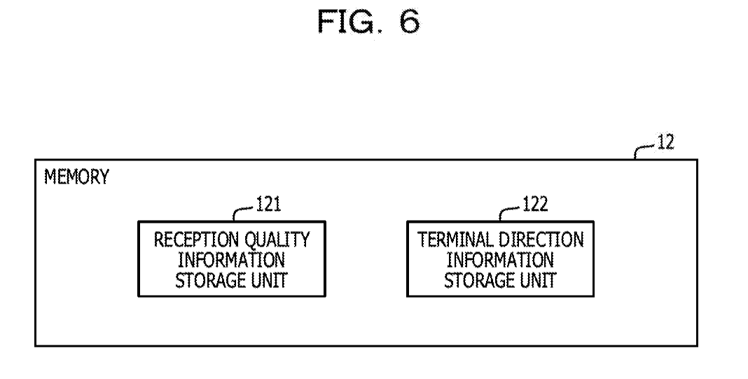

FIG. 6 is a block diagram schematically illustrating the functions of the memory 12 in the base station 1 illustrated in FIG. 5.

As illustrated in FIG. 6, the memory 12 includes a reception quality information storage unit 121 and a terminal direction information storage unit 122.

The reception quality information storage unit 121 stores reception quality information indicating the reception quality of a radio signal at the terminal 2.

The reception quality may be represented by, for example, the reception power of a radio signal at the terminal 2, Precoding Matrix Indicator (PMI), Reference Signal Received Power (RSRP), Reference Signal Received Quality (RSRQ), and Channel Quality Indicator (CQI).

The reception quality information may be information indicating a beam used for transmitting a radio signal having the maximum reception power received by the terminal 2.

The terminal direction information storage unit 122 stores terminal direction information (may be simply referred to as “direction information”) that indicates a direction from the base station 1 to the terminal 2. The terminal direction information may be estimated by a terminal direction estimation unit 115 of a processor 11 described later. The terminal direction information storage unit 122 functions as an example of a storage unit that stores the terminal direction information indicating a direction in which the terminal 2 is located. The terminal direction information may be information obtained by the base station 1 in a predetermined period of time.

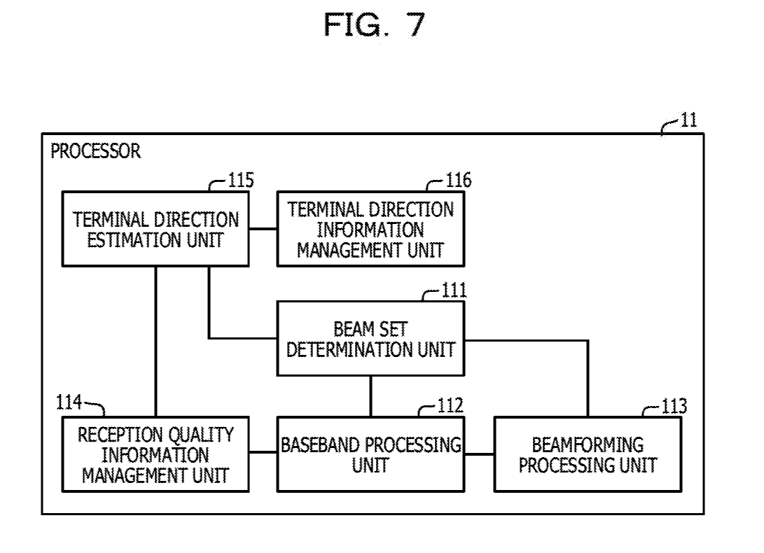

FIG. 7 is a block diagram schematically illustrating the functions of the processor 11 in the base station 1 illustrated in FIG. 5.

The processor 11 is a processing unit that performs, for example, various control and operations and realizes various functions by executing an operating system (OS) or the programs that are stored in the memory 12. That is to say, as illustrated in FIG. 7, the processor 11 may function as a beam set determination unit 111, a baseband processing unit 112, a beamforming processing unit 113, a reception quality information management unit 114, a terminal direction estimation unit 115, and a terminal direction information management unit 116.

In this regard, the programs for realizing the functions of the beam set determination unit 111, the baseband processing unit 112, the beamforming processing unit 113, the reception quality information management unit 114, the terminal direction estimation unit 115, and the terminal direction information management unit 116 may be provided in the form recorded in a computer readable recording medium, for example, a flexible disk, a CD (CD-ROM, CD-R, CD-RW, or the like), a DVD (DVD-ROM, DVD-RAM, DVD-R, DVD+R, DVD-RW, DVD+RW, HD DVD, or the like), a Blu-ray Disc, a magnetic disk, an optical disc, a magneto-optical disk, or the like. The computer (the processor 11 in the present embodiment) then may read the program from the above-described recording medium via a reading device not illustrated in FIG. 7, and transfer and store in an internal storage device or an external storage device. Also, the programs may be recorded in a storage device (recording medium), for example, a magnetic disk, an optical disc, a magneto-optical disk, or the like, and may be supplied from the storage device to the computer via a communication path.

When the functions of the beam set determination unit 111, the baseband processing unit 112, the beamforming processing unit 113, the reception quality information management unit 114, the terminal direction estimation unit 115, and the terminal direction information management unit 116 are realized, the programs stored in the internal storage device (the memory 12 in the present embodiment) may be executed by the computer (the processor 11 in the present embodiment). Also, the programs recorded in the recording medium may be read and executed by the computer.

The processor 11 controls the entire operation of the base station 1. The processor 11 may be a multiprocessor. The processor 11 may be any one of, for example, a central processing unit (CPU), a micro processing unit (MPU), a digital signal processor (DSP), an application specific integrated circuit (ASIC), a programmable logic device (PLD), and a field programmable gate array (FPGA). Also, the processor 11 may be a combination of two or more kinds of components among a CPU, a MPU, a DSP, an ASIC, a PLD, and a FPGA.

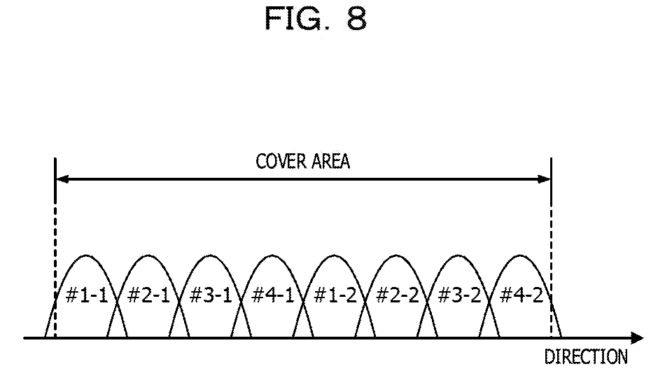

FIG. 8 is a diagram schematically illustrating an example of a beam set that is transmitted by the base station 1 according to the embodiment.

The beam set determination unit 111 is an example of a beam determination unit, and determines a set of plural beams to be sent in order to estimate a terminal direction so as to cover (in other words, “cover overall”) the entire area of the communication area (in other words, the “cover area”) of the base station 1. The plural beams have directivities in a plurality of directions that are individually different. Here, all of the transmission powers of the beams having directivities in the plurality of directions are equal to or higher than a predetermined value. Also, the plurality of directions of the directivities of the individual beams may be directions that are not adjacent with each other (in other words, “apart by a predetermined angle or more”).

In the example illustrated in FIG. 8, beams #1-1 and #1-2 that are transmitted using the same radio resources (for example, a frequency and a code) and time resource, but have different directivities are illustrated. Also, beams #2-1 and #2-2 that are transmitted using the same radio resources and time resource, but have different directivities are illustrated. Further, beams #3-1 and #3-2 that are transmitted using the same radio resources and time resource, but have different directivities are illustrated. Also, beams #4-1 and #4-2 that are transmitted using the same radio resources and time resource, but have different directivities are illustrated.

The baseband processing unit 112 generates a transmission signal and performs reception processing of a reception signal.

The beamforming processing unit 113 performs beamforming on a reception signal and a transmission signal. Also, the beamforming processing unit 113 is an example of a transmission unit, and transmits a transmission signal having been subjected to the beamforming via the wireless communication device 13 and the antenna 15. The beamforming processing unit 113 is an example of a first transmission unit that transmits a plurality of radio signals (may be referred to as a “transmission signal”) using a plurality of beams generated by the beamforming.

The beamforming processing unit 113 may form beams having directivities in a plurality of directions, for example, by stopping the transmission of a radio signal from the antenna 15 for each N (N is an integer) elements. The beamforming processing unit 113 may transmit a plurality of beams by using a directivity pattern having peaks at all the angles φ that satisfy the following expression (1) for any integer n. The angle φ indicates a peak direction of a beam.

$$sin φ = \frac{λ}{( N + 1 ) d} n + sin {φ}_{main} \qquad ( 1 )$$

Note that the beam direction when n=0, that is to say, φₘₐᵢₙ represents the direction of a main lobe, and the beam direction when n≠0 represents the direction of a grating lobe.

Also, the beamforming processing unit 113 may transmit a plurality of beams using a beam forming method based on the Fourier series method described in T. A. Milligan, “Modern antenna Design,” 2nd ed., Wiley-IEEE Press, 2005. pp. 175-178, for example.

The reception quality information management unit 114 obtains the reception quality information transmitted from the terminal 2 via the beamforming processing unit 113 and the baseband processing unit 112. Also, the reception quality information management unit 114 reads the reception quality information stored in the reception quality information storage unit 121, and writes the reception quality information in the reception quality information storage unit 121. The reception quality information management unit 114 may store the reception quality information from the terminal 2 in the reception quality information storage unit 121.

The terminal direction estimation unit 115 estimates the direction in which each terminal 2 is located. That is to say, the terminal direction estimation unit 115 functions as an example of an estimation unit that estimates the direction in which the terminal 2 is located based on the reception quality information. Here, the reception quality information indicates the reception quality of at least one radio signal of the terminal 2 out of a plurality of radio signals used for transmitting a plurality of beams having directivities in a plurality of individual directions in the beam search in the first stage.

Thereby, it is possible to estimate a terminal direction with a small number of beams, and thus to improve the utilization efficiency of the radio resources for estimating the terminal direction. Also, it is possible to perform beam search at the time of new connection of a terminal 2 in a short time, and thus to shorten the delay time until the start of communication.

For the terminal 2 whose estimation result (in other words, “terminal direction information”) of the past terminal direction is stored in the terminal direction information storage unit 122, the terminal direction estimation unit 115 estimates a terminal direction based on the estimation result of the past terminal direction and the reception quality information of the beam. Also, for the terminal 2 whose estimation result of the past terminal direction is not stored in the terminal direction information storage unit 122, the terminal direction estimation unit 115 estimates a terminal direction based on the reception quality information of the beam.

(1) Estimation of the Direction of a Terminal 2 a Past Estimation Result of which is not Held

It is thought that there is a high possibility that the terminal 2 is located in any one of directions in which a beam with a favorable reception quality obtained has been transmitted for each terminal 2. Thus, the terminal direction estimation unit 115 estimates that, for example, the directions in which the beam having the maximum reception quality have been transmitted are candidates for the terminal direction. Also, the terminal direction estimation unit 115 may estimate that the directions in which a plurality of beams having higher reception qualities have been transmitted are candidates of the terminal direction.

The beamforming processing unit 113 transmits beams having a single directivity in sequence to each candidate of the terminal direction estimated by the terminal direction estimation unit 115. Here, if there is a common candidate for a plurality of terminals 2, the terminal direction estimation unit 115 ought to transmit a beam once to the common candidate. That is to say, the beamforming processing unit 113 functions as an example of the second transmission unit that transmits a plurality of radio signals in sequence to a plurality of candidates of the direction in which the terminal 2 is located using a plurality of beams, each of which having a single directivity.

The reception quality information management unit 114 obtains the reception quality information regarding a beam having a single directivity, which has been transmitted by the beamforming processing unit 113, from the terminal 2.

The terminal direction estimation unit 115 estimates the direction in which each terminal 2 is located based on the reception quality information obtained by the reception quality information management unit 114. The terminal direction estimation unit 115 may estimate, for example, the transmission direction of the beam in which the maximum reception quality is obtained to be the direction in which the terminal 2 is located.

That is to say, if the terminal direction information obtained in a predetermined period of time is not stored in the terminal direction information storage unit 122, the terminal direction estimation unit 115 selects a plurality of candidates based on the reception quality information obtained by the beam search in the first stage. The terminal direction estimation unit 115 then estimates the terminal direction in the beam search in the second stage based on the reception quality information. Here, the reception quality information indicates the reception quality of at least one radio signal at the terminal 2 out of a plurality of radio signals transmitted using a plurality of beams. The thickness of the beam transmitted in the second stage may be the same as the thickness of the beam transmitted in the first stage.

Thereby, it is possible to suitably estimate the terminal direction of the terminal 2 that is newly added to the wireless communication system 100 and the terminal 2 having a predetermined period of time or more from the previous estimation of a terminal direction.

The terminal direction estimation unit 115 may estimate the direction in which the terminal 2 is located in combination with the reception quality information of a plurality of beams. For example, if the reception qualities of two beams in the adjacent transmission directions are almost the same, the terminal direction estimation unit 115 may estimate the intermediate direction of the transmission directions of the two beams to be a direction in which the terminal 2 is located. Also, the terminal direction estimation unit 115 may estimate the direction in which the terminal 2 is located in accordance with a magnitude relation of the reception qualities of the two beams in adjacent transmission directions.

(2) Estimation of the Direction of a Terminal 2 a Past Estimation Result of which is Held

The terminal direction estimation unit 115 estimates, for example, the individual directions in which a beam having the maximum reception quality to be candidates for the terminal direction. Also, the terminal direction estimation unit 115 may estimate the directions in which a plurality of beams having higher reception qualities are transmitted to be candidates for the terminal direction.

The terminal direction estimation unit 115 then estimates a candidate that is nearest to the terminal direction obtained as the past estimation result to be the direction in which the terminal 2 is located out of the candidates for the estimated terminal direction.

In this regard, even when a past estimation result is held, for example, if a predetermined time has passed from the previously estimated time, the direction in which the terminal 2 is located may be estimated by “(1) Estimation of the direction of a terminal 2 a past estimation result of which is not held”.

That is to say, when terminal direction information obtained in a predetermined time is stored in the terminal direction information storage unit 122, the terminal direction estimation unit 115 selects a plurality of candidates for the direction in which the terminal 2 is located based on the reception quality information obtained by the beam search in the first stage. The terminal direction estimation unit 115 then estimates a direction in which the terminal 2 is located based on the plurality of candidates and the terminal direction information in the beam search in the second stage.

In this manner, the direction of the terminal 2 is estimated by using beams having the directivities in a plurality of directions by the beam search in the first stage so that it is possible to estimate a terminal direction with a smaller amount of radio resources compared with the case of using beams having a single directivity.

In this regard, the array configuration of a plurality of antennas 15 is not limited to a configuration in which the antenna elements are arranged in one dimension, and may be, for example, a planar antenna configuration in which antenna elements are arranged on a plane. In this case, beams having directivities in a plurality of directions in either dimension horizontally or vertically may be used, or beams having directivities in a plurality of directions in both horizontally and vertically may be used.

2.2 Operation Example

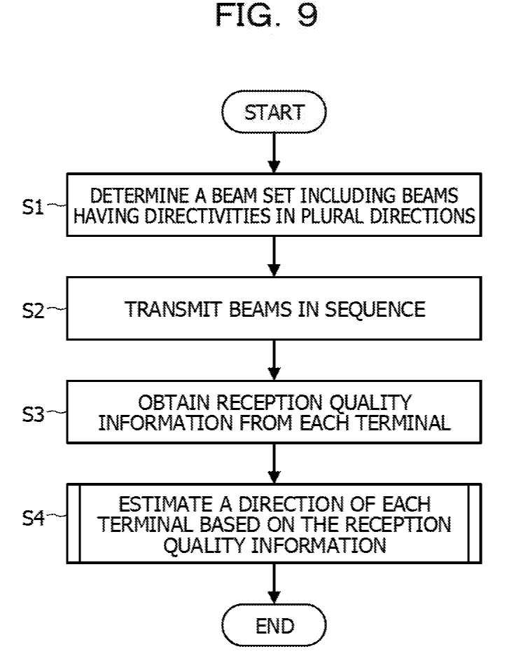

A description will be given of estimation operation of a terminal direction in the wireless communication system 100 according to the embodiment, which is configured as described above, with reference to a flowchart (steps S1 to S4) illustrated in FIG. 9.

The beam set determination unit 111 determines a beam set including beams having directivities in a plurality of directions (step S1).

The beamforming processing unit 113 transmits in sequence a plurality of beams included in a beam set determined by the beam set determination unit 111 (step S2).

The reception quality information management unit 114 obtains the reception quality information of the plurality of beams transmitted by the beamforming processing unit 113 from each of the terminals 2 (step S3).

The terminal direction estimation unit 115 estimates a direction in which each terminal 2 is located based on the reception quality information obtained by the reception quality information management unit 114 (step S4). The processing then terminates.

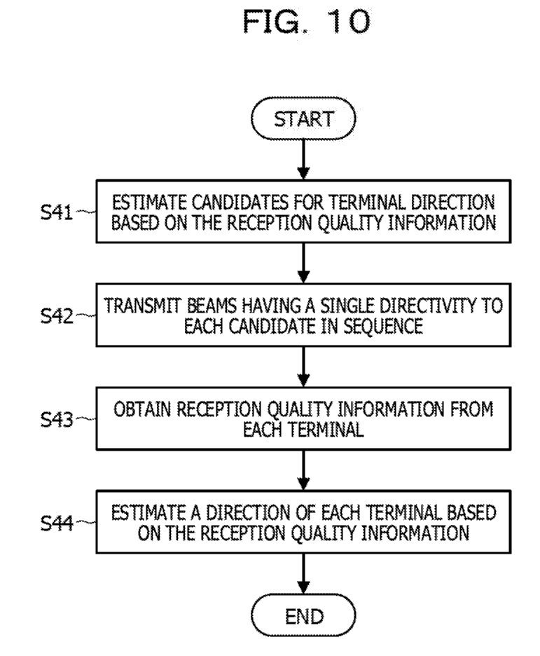

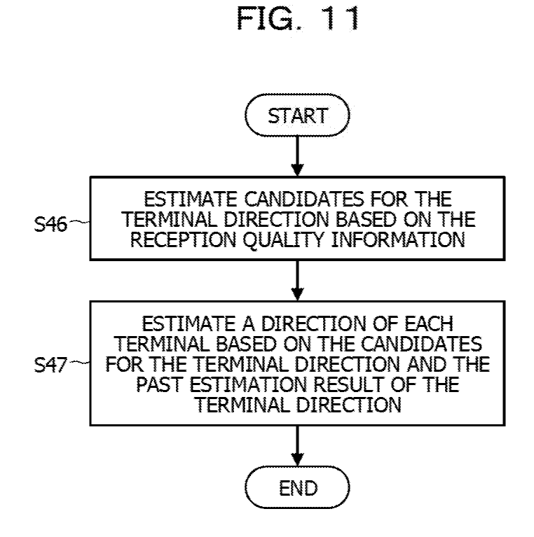

The details of step S4 differ between the terminal 2 a past estimation result of which is not held and the terminal 2 a past estimation result of which is held, and thus the details thereof will be described using FIG. 10 and FIG. 11, respectively.

Next, a description will be given of the processing of step S4 in FIG. 9 in the case where the past estimation result of the terminal direction in the wireless communication system 100 according to the embodiment is not held with reference to a flowchart (steps S41 to S44) illustrated in FIG. 10.

the terminal direction estimation unit 115 estimates the candidates for the terminal direction based on the reception quality information obtained by the reception quality information management unit 114 (step S41).

The beamforming processing unit 113 transmits a plurality of beams having a single directivity to each candidate of the terminal direction in sequence (step S42).

The reception quality information management unit 114 receives the reception quality information of the beam having a single directivity, which was transmitted by the beamforming processing unit 113, from each of the terminals 2 (step S43).

The terminal direction estimation unit 115 estimates the direction in which each of the terminals 2 is located based on the reception quality information reception quality information received by the management unit 114 (step S44). The processing then terminates.

Next, a description will be given of the processing of step S4 in FIG. 9, which is the case where an estimation result of the past terminal direction in the wireless communication system 100 according to the embodiment is held with reference to a flowchart (steps S46 and S47) illustrated in FIG. 11.

The terminal direction estimation unit 115 estimates the candidates for the terminal direction based on the reception quality information obtained by the reception quality information management unit 114 (step S46).

The terminal direction estimation unit 115 estimates a direction in which each of the terminals 2 is located based on the estimated candidates of the terminal direction and the past estimation result of the terminal direction (step S47). The processing then terminates.

3. Variations

Next, descriptions will be given of variations of the embodiment.

3.1 First Variation

In the embodiment described above, a description has been given of the example in which a beam set that covers a cover area of the base station 1 is used as a beam set used for the estimation of the terminal direction in the first stage of the beam search. However, in order to track a moving terminal 2, the estimation of the terminal direction may be carried out with a smaller number of beams. The movement range of the terminal 2 in a predetermined period of time is limited, and thus beams may be transmitted only in the direction having a high probability of the existence of the terminal 2 based on the estimation result of the past terminal direction.

In a first variation, a description will be given of an example in which the terminal direction is estimated using a beam set determined based on the past estimation result of the terminal direction.

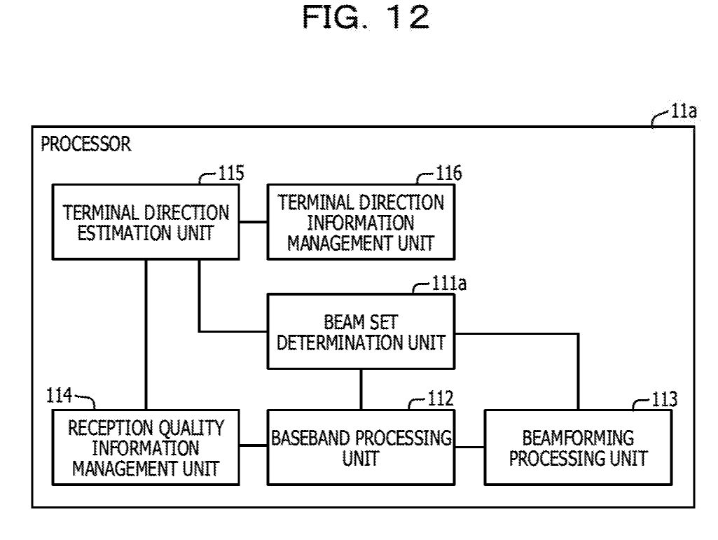

FIG. 12 is a block diagram schematically illustrating the functions of a processor 11a in the base station 1 in the first variation.

A processor 11a according to the first variation includes a beam set determination unit 111a in place of the beam set determination unit 111 in the processor 11 according to the embodiment described above.

The beam set determination unit 111a determines a beam set using the terminal direction information stored in the terminal direction information storage unit 122 via the terminal direction information management unit 116.

The beam set determination unit 111a determines the direction having a high probability of the existence of the terminal 2 as a candidate (in other words, a “tracking candidate”) for performing a beam search (in other words, “tracking”) for each of the terminals 2. The beam set determination unit 111a determines, for example, the direction in the vicinity of the estimated terminal direction in the past to be a candidate for the tracking.

The beam set determination unit 111a selects any one direction out of the tracking candidates not included in the beam direction that has been added to the beam set as a beam to be added to the beam set next.

The direction in which a beam is capable of being transmitted using the same frequency resource and time resource is limited by the beam forming method performed by the beamforming processing unit 113. For example, in the method described in the embodiment described above, a beam having the directivity in the direction indicated by the expression (1) is formed. Accordingly, the beam set determination unit 111a extracts tracking candidates that are capable of being transmitted at the same time with the direction of the selected beam.

The beam set determination unit 111a selects any one direction out of the extracted tracking candidates as a direction having an additional directivity.

The beam set determination unit 111a repeatedly selects a tracking candidate until the number of the selected tracking candidates reaches a predetermined number. Here, the predetermined number ought to be determined based on, for example, the past reception quality information of the terminal 2 having the selected direction as a tracking candidate.

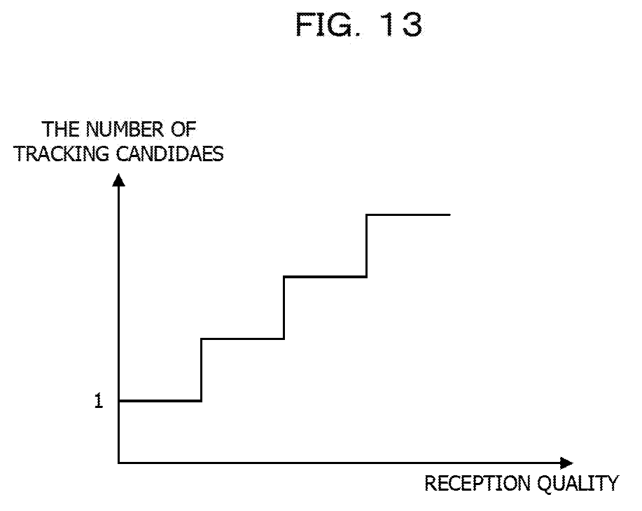

FIG. 13 is a block diagram schematically illustrating a relationship between a reception quality of the terminal 2 according to the first variation and the upper limit value of the number of tracking candidates.

The larger the number of directions in which a beam has a directivity (in other words, “the number of tracking candidates”), the weaker the transmission power to each of the directions. Accordingly, as illustrated in FIG. 13, the lower the reception quality of the terminal 2 having the selected direction as a tracking candidate, the lower the upper limit value (in other words, the “predetermined number”) of the tracking candidate to be selected may be set.

That is to say, the beam set determination unit 111a is an example of a directivity setting unit that sets a smaller number of directivities of each beam in the beam search in the first stage as the parameter based on the reception qualities of a plurality of terminals 2 is lower. Here, the parameter based on the reception qualities of a plurality of terminals 2 becomes low as the maximum value, the average value, or the representative value of the reception power of the terminals 2 becomes low.

Thereby, it is possible to avoid the occurrence of the reception quality of the beam in the terminal 2 becoming too low.

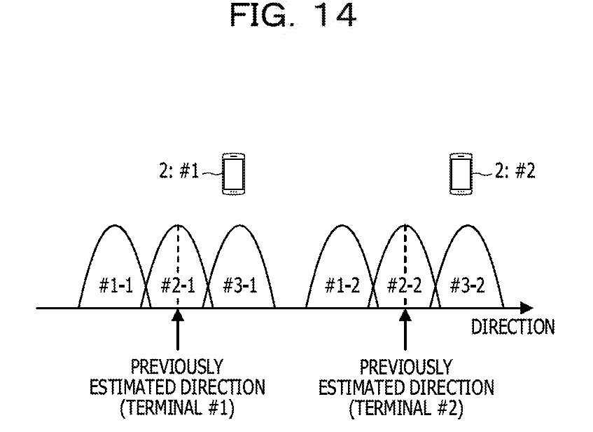

FIG. 14 is a diagram schematically illustrating an example of a beam set transmitted by the base station 1 according to the first variation.

The beam set determination unit 111a determines a beam set including the beams having the directivities in the direction in the vicinity of the previously estimated direction. Each of the beams included in the beam set has a plurality of directivities.

In the example illustrated in FIG. 14, the beam set determination unit 111a determines a beam set including beams #1-1, #2-1, #3-1, #1-2, #2-2, and #3-2 having directivities in the direction in the vicinity of the previously estimated direction of the terminals #1 and #2.

Here, the beams #1-1, #2-1, and #3-1 have the directivities in the direction in the vicinity of the previously estimated direction of the terminal #1, and the beams #1-2, #2-2, and #3-2 have the directivities in the direction in the vicinity of the previously estimated direction of the terminal #2.

The beam #1-1 and the beam #1-2 are the beams that are transmitted using the same frequency resource and time resource. The beam #2-1 and the beam #2-2 are the beams that are transmitted using the same frequency resource and time resource. Further, the beam #3-1 and the beam #3-2 are the beams that are transmitted using the same frequency resource and time resource.

In this regard, in order to respond to a new connection of the terminal 2 having no estimation result of the terminal direction that is stored in the terminal direction information storage unit 122, a beam set that covers the entire range of the cover area may be determined at certain period intervals as described in the above embodiment.

That is to say, the beam set determination unit 111a functions as an example of the beam determination unit that determines a plurality of beams so as to cover the entire communication area of the base station 1.

Thereby, if it is difficult to obtain the rough direction of the terminal 2 from the terminal direction information, a plurality of beams that cover the entire range of the communication area of the base station 1 are transmitted, and thus it is possible to reliably estimate the direction in which the terminal 2 is located.

Also, the beam set determination unit 111a functions as an example of the beam determination unit that determines a plurality of beams that are used for transmitting a plurality of radio signals in the beam search in the first stage based on the terminal direction information obtained in a predetermined period of time, which is stored in the terminal direction information storage unit 122.

Thereby, it is possible to omit the beam search in the direction in which there is a low probability of the existence of the terminal 2 the past terminal direction of which was estimated, and thus to efficiently estimate the terminal direction.

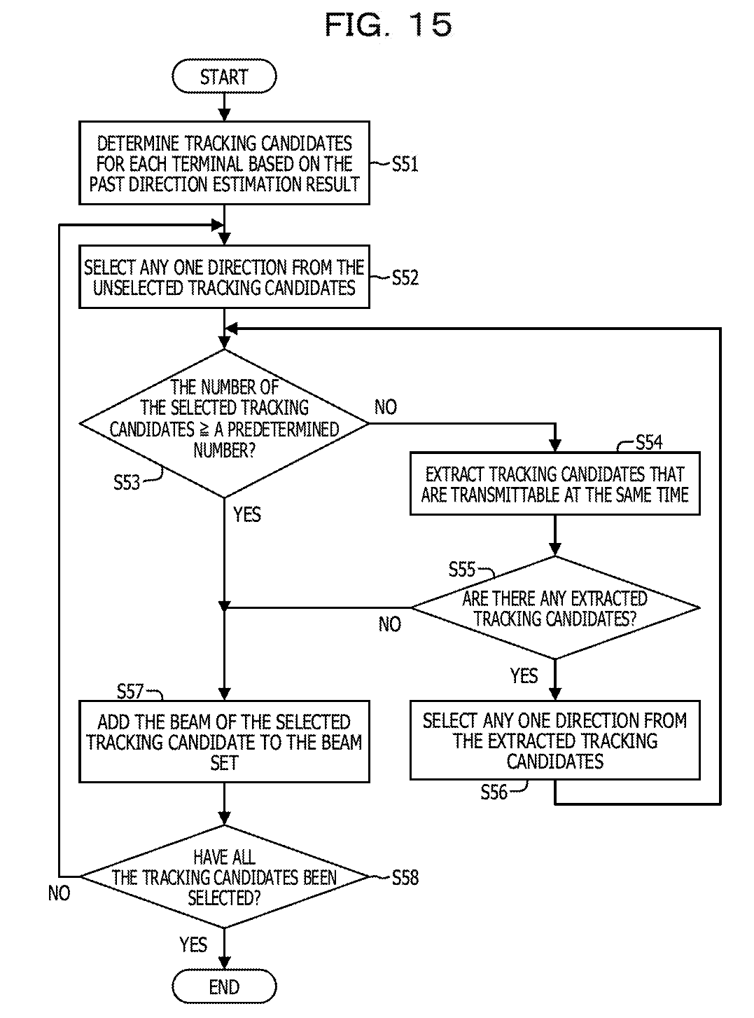

A description will be given of determination operation of the beam set in the base station 1, which is configured as described above, according to the first variation with reference to a flowchart (steps S51 to S58) illustrated in FIG. 15.

The beam set determination unit 111a determines tracking candidates for each terminal 2 based on the past estimation result of the terminal direction (step S51).

The beam set determination unit 111a selects a tracking candidate in any one direction from the unselected tracking candidates (step S52).

The beam set determination unit 111a determines whether or not the number of the selected tracking candidates is equal to or larger than a predetermined number (step S53).

If the selected number of tracking candidates is not equal to or larger than the predetermined number (refer to No in step S53), a tracking candidate that is capable of being transmitted at the same time with the selected tracking candidate is extracted (step S54).

The beam set determination unit 111 determines whether or not the extracted tracking candidates are existent (step S55).

If the extracted tracking candidates do not exist (refer to No in step S55), the processing proceeds to step S57.

On the other hand, if the extracted tracking candidates exist (refer to Yes in step S55), the beam set determination unit 111a selects any one direction out of the extracted tracking candidates (step S56). The processing then returns to step S53.

In step S53, if the selected number of tracking candidates is equal to or larger than the predetermined number (refer to Yes in step S53), the beam set determination unit 111 adds the beam of the selected tracking candidate to the beam set (step S57).

The beam set determination unit 111a determines whether or not all the tracking candidates have been selected (step S58).

If there is an unselected tracking candidate (refer to No in step S58), the processing returns to step S52.

On the other hand, if all the tracking candidates have been selected (refer to Yes in step S58), the processing terminates.

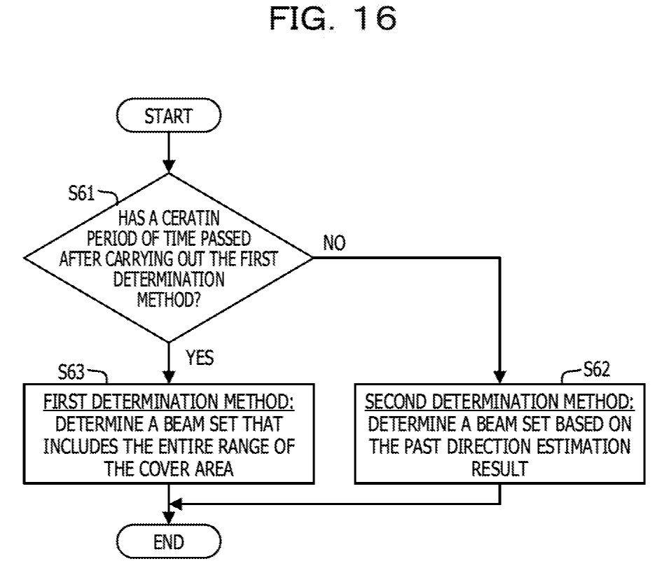

Next, a description will be given of a change operation of beam set determination methods according to the first variation with reference to a flowchart (steps S61 to S63) with reference to FIG. 16.

The beam set determination unit 111a determines whether or not a certain time period has passed after carrying out the first determination method (step S61). Here, the first determination method is a method of determining a beam set that covers the entire range of the cover area of the base station 1.

If a certain time period has not passed after carrying out the first determination method (refer to No in step S61), the beam set determination unit 111a determines the beam set by the second determination method (step S62). The processing then terminates. Here, the second determination method is a method of determining a beam set based on the estimation result of the past terminal direction.

On the other hand, if a certain time period has passed after carrying out the first determination method (refer to Yes in step S61), the beam set determination unit 111a determines a beam by the first determination method (step S63). The processing then terminates.

3.2 Second Variation

In the above-described embodiment and variation, the descriptions have been given of the case where the base station 1 transmits a signal using a beam so that the terminals 2 measure the reception quality of each beam. The measurement of the reception quality may be carried out by the base station 1 using signals transmitted from the terminals 2. In this case, the terminals 2 do not have to feed back the reception quality information to the base station 1, and thus it is possible to further improve the utilization efficiency of the wireless communication resources.

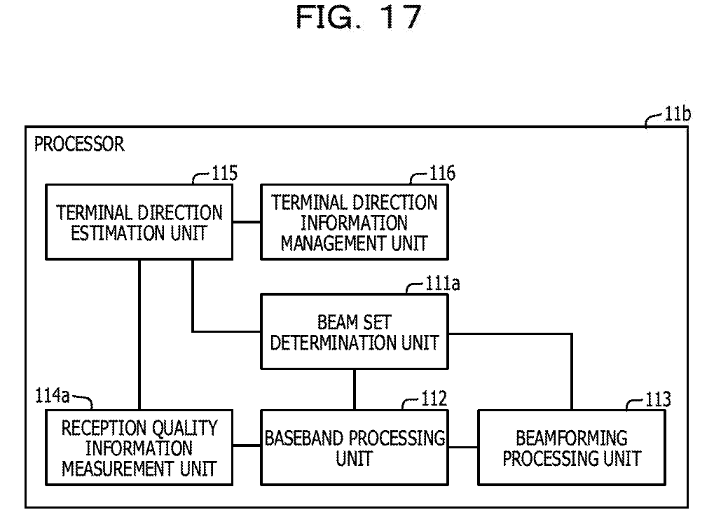

FIG. 17 is a block diagram schematically illustrating the functions of a processor 11b in a base station 1 according to a second variation.

The processor 11b according to the second variation includes a reception quality information measurement unit 114a in place of the reception quality information management unit 114 in the processor 11a according to the first variation.

The reception quality information measurement unit 114a measures the reception quality of the radio signal based on the radio signal received from the terminal 2.

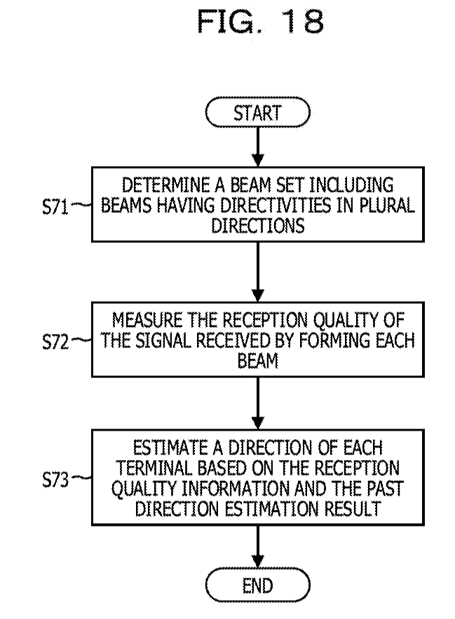

A description will be given of estimation operation of the terminal direction in the base station 1, which is configured as described above, according to the second variation with reference to a flowchart (steps S71 to S73) illustrated in FIG. 18.

The beam set determination unit 111 determines a beam set including the beams having directivities in a plurality of directions (step S71).

The reception quality information measurement unit 114a measures the reception quality of the signal from the terminal 2 by forming each beam (step S72).

The terminal direction estimation unit 115 estimates the direction in which each terminal 2 is located based on the reception quality information indicating the reception quality measured by the reception quality information measurement unit 114a and the estimation result of the past terminal direction (step S73). The processing then terminates.

4. Others

The disclosed technique is not limited to each of the embodiments described above, and it is possible to make various variations without departing from the spirit and scope of each of the embodiments. It is possible to optionally select each component and each processing of each of the embodiments if desired, or to suitably combine each component and each processing of each of the embodiments.

In the above-described embodiment, first variation, and second variation, the descriptions have been given of the examples in which the base station 1 estimates the direction in which the terminal 2 is located by the beam search. However, the present disclosure is not limited to this. For example, the terminal 2 may estimate the direction in which the base station 1 is located by the beam search. In this case, the terminal 2 may have the same configuration as that of the base station 1 illustrated in FIG. 5, or the like. That is to say, the terminal 2 may be an example of the wireless communication apparatus, and the base station 1 may be an example of the reception apparatus.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a memory; and
a processor coupled to the memory and the processor configured to:
transmit a plurality of radio signals for a plurality of directions by forming a plurality of first beams, each of plurality of first beams having a directivity in at least two directions;
estimate a direction in which a reception apparatus is located based on first reception quality information indicating a reception quality when the reception apparatus receives at least one radio signal included in the plurality of radio signals, and
perform a radio communication with the reception apparatus by forming a beam corresponding to the estimated direction.

2. The wireless communication apparatus according to claim 1, wherein
the memory configured to store direction information indicating a location of the reception apparatus in a predetermined period of time; and wherein
the processor is further configured to:
specify a plurality of candidates of direction based on the first reception quality information when the direction information is not stored in the memory;
transmit a plurality of radio signals by forming a plurality of second beams corresponding to the plurality of candidates, each of the plurality of second beams having a directivity in single direction; and
estimate the direction in which the reception apparatus is located based on second reception quality information indicating a reception quality when the reception apparatus receives at least one radio signal included in the plurality of radio signals transmitted by forming the plurality of second beams.

3. The wireless communication apparatus according to claim 1, wherein the processor is configured to:
estimate the direction in which the reception apparatus is located based on first reception quality information and the direction information when the direction information is stored in the memory.

4. The wireless communication apparatus according to claim 1, wherein
an entire area of a communication area of the wireless communication apparatus is encompassed by the plurality of first beams.

5. The wireless communication apparatus according to claim 3, wherein the processor is further configured to:
determine the plurality of directions corresponding to the plurality of first beams based on the direction information stored in the memory

6. The wireless communication apparatus according to claim 1, wherein the processor is configured to:
set a smaller number of the directivities in the plurality of respective first beams as a parameter based on a reception quality of a plurality of the reception apparatuses is lower.

7. A beam search method comprising:
transmitting a plurality of radio signals for a plurality of directions by forming a plurality of first beams, each of plurality of first beams having a directivity in at least two directions;
estimating a direction in which a reception apparatus is located based on first reception quality information indicating a reception quality when the reception apparatus receives at least one radio signal included in the plurality of radio signals, and
performing a radio communication with the reception apparatus by forming a beam corresponding to the estimated direction.

8. A non-transitory computer-readable storage medium storing a beam search program that causes a computer to execute a process, the process comprising:
transmitting a plurality of radio signals for a plurality of directions by forming a plurality of first beams, each of plurality of first beams having a directivity in at least two directions;
estimating a direction in which a reception apparatus is located based on first reception quality information indicating a reception quality when the reception apparatus receives at least one radio signal included in the plurality of radio signals, and
performing a radio communication with the reception apparatus by forming a beam corresponding to the estimated direction.
